(19) United States
(12) Patent Application Publication
(10) Pub. No.: US 2001/0001205 A1
(43) Pub. Date: May 17, 2001

(54) Semiconductor ceramics having negative temperature coefficients of resistance

(76) Inventors: Terunobu Ishikawa, Nagaokakyo-shi (JP); Akinori Nakayama, Nagaokakyo-shi (JP); Hideaki Niimi, Nagaokakyo-shi (JP); Hiroshi Takagi, Nagaokakyo-shi (JP); Kunisaburo Tomono, Nagaokakyo-shi (JP); Kimiyo Kittaka, Ibaraki-city (JP); Ayumi Kittaka, Ibaraki-city (JP); Megumi Kittaka, Ibaraki-city (JP)

Correspondence Address: OSTROLENK FABER GERB & SOFFEN, 1180 AVENUE OF THE AMERICAS, NEW YORK, NY, 100368403

(21) Appl. No.: 09/754,603

(22) Filed: Jan. 4, 2001

Related U.S. Application Data
(62) Division of application No. 09/222,676, filed on Dec. 29, 1998.
Application No. 09/222,676 is a continuation of application No. 08/632,266, filed on Apr. 15, 1996, now abandoned.
Application No. 08/632,266 is a continuation-in-part of application No. 08/190,600, filed on Feb. 2, 1994, now Pat. No. 5,502,388.

(30) Foreign Application Priority Data
Feb. 5, 1993 (JP) 5-18997
Feb. 26, 1993 (JP) 5-38328
Nov. 4, 1993 (JP) 5-275443

(51) Int. Cl. H01B 1/00

(52) U.S. Cl. 252/500

(57) ABSTRACT

A semiconductive ceramic having a negative temperature coefficient of resistance, includes an oxide of a rare earth transition element excluding Ce and including Y, with the addition of at least one of the following elements: Si, Zr, Hf, Ta, Sn, Sb, W, Mo, Te or Ce.

### CROSS-REFERENCE TO RELATED APPLICATIONS

1. This is a continuing application of pending U.S. application Ser. No. 08/190,300, filed Feb. 2, 1994.

### BACKGROUND OF THE INVENTION

2. 1. Field of the Invention

3. The present invention relates to semiconductive ceramics having negative temperature coefficients of resistance.

4. 2. Description of the Background Art

5. In general, an element for preventing an inrush current is prepared from an element having a negative temperature coefficient of resistance (NTC element) , whose electric resistance value decreases with a rise in temperature. This NTC element suppresses an inrush current due to its high resistance value at room temperature, and thereafter increases in temperature and decreases in resistance by self heating, to reduce power consumption in a stationary state.

6. In a switching power source, for example, an inrush current flows at the instant the switch is turned on. An NTC element is employed for absorbing such an initial inrush current. When the switch is turned on, therefore, the NTC element suppresses the inrush current. The NTC element thereafter increases in temperature and decreases in resistance by self heating, to reduce power consumption in a stationary state.

7. In practice, when a toothed wheel of a gear requires a supply of lubricating oil upon starting of a motor, and the gear is immediately rotated at a high speed by the motor, the lubricating oil is not sufficiently supplied which can cause damage to the toothed wheel. When a lapping machine for grinding a surface of ceramics by rotating a grindstone is rotated at a high speed, immediately upon starting of a driving motor, on the other hand, the ceramics may be cracked.

8. In order to solve each of the aforementioned problems, it is necessary to delay the starting of the motor for a constant period. The NTC element is employed as an element for delaying the starting of the motor in such a manner.

9. The NTC element reduces a terminal voltage of the motor in starting, whereby it is possible to delay the starting of the motor. Thereafter the NTC element increases in temperature and decreases in resistance by self heating, so that the motor is normally rotated in a stationary state.

10. The aforementioned element for preventing an inrush current or delaying rotor starting is generally formed by an NTC element which is prepared from a transition metal oxide having a spinel structure.

11. However, the conventional NTC element has such a disadvantage that the rate of reduction in resistance (constant B) caused by a temperature rise cannot be more than 3200 K. Therefore, the resistance value of the NTC element cannot be sufficiently reduced in a high-temperature state, and hence power consumption inevitably increases in a stationary state. When the NTC element is in the form of a disk, for example, the resistance value at high-temperatures can be sufficiently reduced by enlarging its diameter or making its thickness thinner. However, such a countermeasure is contradictory to requirements for miniaturization of an electronic component. Further, there are limits to thinning to satisfy strength requirements.

12. As a solution to these problems, multilayer NTC elements have been prepared by stacking a plurality of ceramics layers interposed with a plurality of internal electrodes and forming a pair of external electrodes on side surfaces of the laminate for alternately electrically connecting the internal electrodes with the pair of external electrodes.

13. However, the internal electrodes which are opposed to each other are so close to each other that the multilayer NTC element may be broken by a current exceeding several amperes.

14. The inventors have made various composition experiments and practical tests to deeply study materials showing negative temperature coefficients of resistance, and noted oxides of rare earth transition elements. The rare earth transition element oxides have such characteristics that B constants increase and specific resistance decrease with temperature rises. Such characteristics are described in literature (Phys. Rev. B6, [3] 1021 (1972)) by V. G. Bhide and D. S. Rajoria.

15. Although these rare earth transition element oxides exhibit small resistance values at high temperatures as compared with the conventional transitional metal oxides having spinel structures, they exhibit small B constants, with no provision of practical and meritorious effects.

### SUMMARY OF THE INVENTION

16. The present invention has been proposed in order to solve the aforementioned problems, and an object thereof is to provide semiconductive ceramics having negative temperature coefficients of resistance with low resistivity and a high B constant in a stationary state, to enable feeding of a heavy current.

17. According to the present invention, semiconductive ceramics are provided having negative temperature coefficients of resistance, which are mainly composed of an oxide of a rare earth transition element excluding Ce and including Y, with the addition of at least one of Si, Zr, Hf. Ta, Sn, Sb, W, Mo, Te and Ce.

18. The rare earth transition element oxides, such as LaCoO₃ or SmNiO₃, are not restricted in particular. LaCoO₃ exhibits such practical characteristics that its B constant extremely increases with a temperature rise, with small resistivity at room temperature. Among rare earth elements, Ce is excluded since it is difficult to obtain an oxide with a transition metal. On the other hand, Y is included in the group of rare earth elements in the present invention since this element can attain characteristics and effects which are similar to those of the rare earth elements.

19. According to the present invention, preferably 0.001 to 10 mole percent, more preferably 0.1 to 5 mole percent of the aforementioned additive is added to the main component.

20. It is possible to obtain a high B constant by adding at least 0.001 mole percent of at least one of Si, Zr, Hf, Ta, Sn, Sb, W, Mo, Te and Ce to the main component of a rare earth transition element oxide, since the resistance value at room temperature can be increased while maintaining a low resistance value at a high temperature. If the content of the additive exceeds 10 mole percent, however, the B constant at a high temperature is reduced below that of an NTC element which is composed of a transition metal oxide having a spinel structure. Therefore, the content of the additive is preferably set in a range of 0.001 to 10 mole percent.

21. As to the rare earth transition element oxide, the mole ratio of a rare earth element to a transition element need not be restricted to 1:1 but may be varied. Even if the mole ratio is varied within a range of 0.6 to 1.1, it is possible to obtain a B constant which is substantially identical to that obtained at the mole ratio of 1:1. If the mole ratio is less than 0.6 or in excess of 1.1, however, power consumption in a stationary state so increases that the semiconductive ceramics cannot be applied to a circuit which is supplied with a heavy current, since the resistance value will not decrease upon a temperature rise.

22. As hereinabove described, the inventive semiconductive ceramic having a negative temperature coefficient of resistance is composed of a rare earth transition element oxide with the addition of a prescribed element, whereby it is possible to obtain an element having a high B constant at a high temperature, since the resistance value at a room temperature can be increased with maintaining low resistance value at a high temperature. Therefore, it is possible to sufficiently reduce a resistance value in a temperature rise state for reducing power consumption in a stationary state, so that the element can be applied to a circuit which is supplied with a heavy current.

23. Thus, the semiconductive ceramics according to the present invention is applicable to an NTC element for preventing an inrush current in a switching power source which is supplied with a heavy current. In practice the NTC element of the present invention can be used for delaying the start of a motor.

24. While the semiconductive ceramics having negative temperature coefficients of resistance according to the present invention can be applied to an element for preventing a rush current or for delaying motor starting, the present invention is not restricted to such applications.

25. In the rare earth transition element oxide, the mole ratio of the rare earth element such as La to the transition element such as Co can be in a range of about 0.600 to 0.989. If the mole ratio is less than 0.600, a resistance value in a temperature-elevated state cannot be fully lowered, so that the power consumption in a steady state increases, whereby the present inventive ceramics cannot be applied to a circuit through which a large current flows.

26. Further, if the mole ratio exceeds 0.989, the composition becomes A-site rich when all the additives are solved in A-site, whereby an excess amount of La₂O₃ is deposited in a crystal boundary. La₂O₃ shows a high water absorption property and the same absorbs water in air to change to La(OH)₃, when the volume becomes larger. Thus, the sintered body breaks in its particle boundary to change to sand like particles. Neutral disintegration of the rare earth transition element oxides wherein La exists in an A-site is described in Journal of the Ceramic Society of Japan 101 [12] pp. 1409-1414 (1993).

27. The foregoing and other objects, features, aspects and advantages of the present invention will become more apparent from the following detailed description of the present invention when taken in conjunction with the accompanying drawings.

### BRIEF DESCRIPTION OF THE DRAWINGS

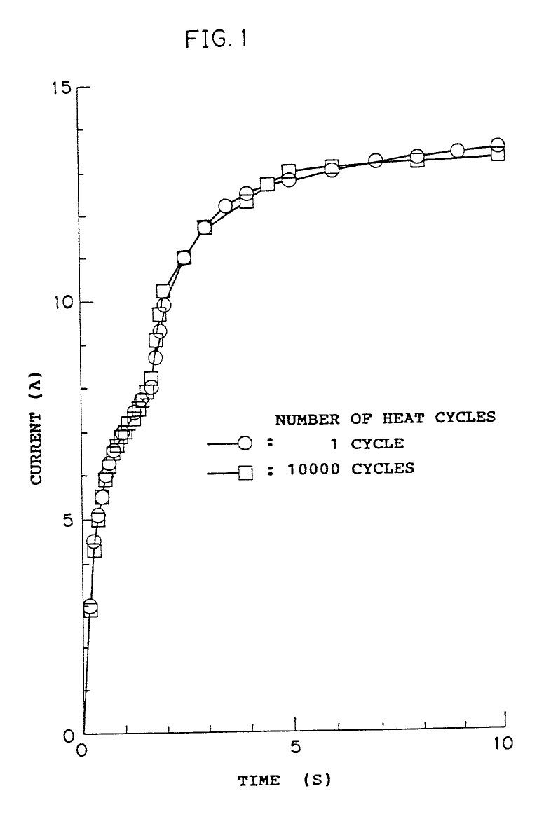

28. FIG. 1 is a characteristic diagram showing the results of a test which was made by connecting in series an NTC element to a switching power source, and measuring the time change of a switching power source current upon power supply at a temperature of 25°C.; and

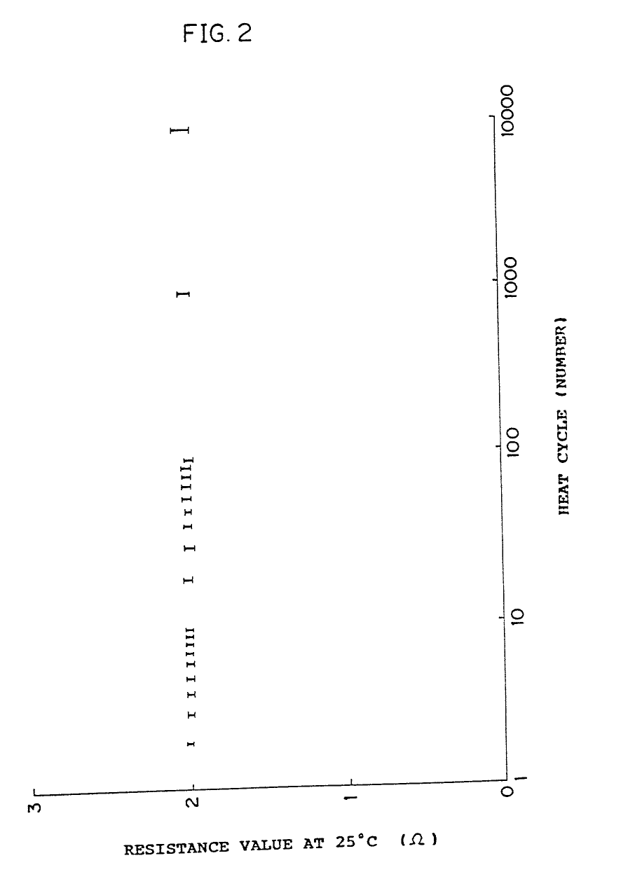

29. FIG. 2 is a characteristic diagram showing the relationship between the number of times of a repetitive energization test and resistance values at a temperature of 25°C.

### DESCRIPTION OF THE PREFERRED EMBODIMENTS

### EXAMPLE 1

30. This Example was carried out on a rare earth transition element oxide of LaCoO₃.

31. First, LaCoO₃ powder materials were prepared in the following manner: Respective powder materials of CO₃O₄ and La₂O₃ were weighed so that La was at a mole ratio of 0.95 to Co. Prescribed amounts of additives shown in Tables 1, 2 and 3 were added to the powder materials, which in turn were wet-blended for 16 hours in ball mills employing nylon balls. Thereafter the powder materials were dehydrated, dried and calcined at 1000°C. for 2 hours. Referring to Table 1, asterisked (*) amounts are out of the scope of the present invention.

32. The resulting calcined powder materials were pulverized by jet mills. Binders were added to the powder materials, which in turn were again wet-blended for 5 hours in ball mills employing nylon balls, filtered, dried and thereafter pressure-molded into the form of disks. The disks were fired in the atmosphere at 1400° C. for 2 hours to obtain sintered bodies. Both major surfaces of the sintered bodies were coated with platinum paste by screen printing, and baked at 1000° C. for 2 hours, to be provided with electrodes. NTC elements were thus obtained.

33. The electric characteristics of specific resistance values and B constants of the NTC elements were measured. Tables 1 to 3 as well as Tables 4 to 10 described later show resistivity values which were measured at a temperature of 25° C. Assuming that p(T) and p(T_{O}) represent resistivity values at temperatures T and T_{O} respectively and In represents a natural logarithm, each B constant, which is a constant showing resistance change caused by temperature change, is defined as follows:

B(T)=[Inₚ(T_{O})−Inₚ(T)]/(1/T_{O}−1/T)

34. Temperature change caused by the temperature increases with this value.

35. Referring to Tables 1, 2 and 3, the B constants at −10° C. and 140° C. are defined as follows:

B constant (−10°C.)=[Inₚ(−10°C.)−Inₚ(25°C.)]/[1/(−10+273.15)−1/(25+273.5)]

B constant (140°C.)=[Inₚ(−25°C.)−Inₚ(140°C.)]/[1/(25+273.15)−1/(140+273.5)]

36. FIGS. 1 and 2 show the results of a repetitive energization test which was made on a sample according to Example 1, containing 1 mole percent of Zr. FIG. 1 shows the results of the test which was made by connecting in series an NTC element to a switching power source and measuring the time change of a switching power source current upon power supply at a temperature of 25° C. FIG. 2 is a characteristic diagram showing the relation between the number of times of the repetitive energization test and resistance values at a temperature of 25° C. In this repetitive energization test, the NTC element was energized with a current for 1 minute and thereafter the power source was turned off for 30 minutes to cool the element to 25° C. every cycle. As clearly understood from FIGS. 1 and 2, no characteristic change was recognized even after 10000 cycles. Further, no NTC element was broken when currents of 200 A were continuously applied to 100 NTC elements. Thus, it was confirmed that the inventive NTC element is applicable to a heavy current.

TABLE 1

| | | | | | B Constant |
|---|---|---|---|---|---|
| | Additional | Content | Resistivity | B Constant | (140° C.) |
| No. | Element | (mol %) | (Ω · cm) | (−10° C.) (K) | (K) |
| 1-1 | Zr | 0* | 49 | 520 | 1590 |
| 1-2 | Zr | 0.0005* | 8.4 | 890 | 2510 |
| 1-3 | Zr | 0.001 | 11.1 | 1220 | 3020 |
| 1-4 | Zr | 0.01 | 14.8 | 1650 | 3780 |
| 1-5 | Zr | 0.1 | 18.7 | 2150 | 4480 |
| 1-6 | Zr | 1 | 19.8 | 2620 | 4730 |
| 1-7 | Zr | 10 | 13.6 | 1600 | 3290 |
| 1-8 | Zr | 20* | 4.7 | 790 | 1790 |

37.

TABLE 2

| | Additional | Content | Resistivity | B Constant | B Constant |
|---|---|---|---|---|---|
| No. | Element | (mol %) | (Ω · cm) | (−10° C.) (K) | (140° C.) (K) |
| 1-9 | Si | 0.05 | 17.4 | 2010 | 4290 |
| 1-10 | Mo | 0.05 | 16.7 | 1820 | 4580 |
| 1-11 | Sn | 0.5 | 20.5 | 2400 | 4680 |
| 1-12 | Sb | 1 | 17.3 | 1970 | 4450 |
| 1-13 | Te | 1 | 20.2 | 2630 | 4530 |
| 1-14 | Hf | 5 | 18.4 | 2260 | 4310 |
| 1-15 | Ta | 5 | 17.5 | 2100 | 4570 |
| 1-16 | W | 10 | 16.4 | 1990 | 4320 |
| 1-17 | Ce | 10 | 17.0 | 2090 | 4480 |

38.

TABLE 3

| | Additional | Content | Resistivity | B Constant | B Constant |
|---|---|---|---|---|---|
| No. | Element | (mol %) | (Ω · cm) | (−10° C.) (K) | (140° C.) (K) |
| 1-18 | Zr | 0.05 | 19.6 | 2280 | 4230 |
| | Mo | 0.05 | | | |
| 1-19 | Zr | 1 | 18.3 | 2570 | 4550 |
| | Sn | 0.5 | | | |
| 1-20 | Zr | 0.05 | 17.8 | 2130 | 4510 |
| | Sn | 0.05 | | | |
| | W | 0.05 | | | |
| 1-21 | Zr | 1 | 16.2 | 2460 | 4290 |
| | Mo | 0.5 | | | |
| | Ce | 0.5 | | | |

### EXAMPLE 2

39. This Example was carried out on a rare earth transition element oxide of LaCrO₃.

40. First, LaCrO₃ powder materials were prepared in the following manner: Respective powder materials of La₂O₃ and Cr₂O₃ were weighed so that Co was at a mole ratio of 0.95 to Cr. Additives shown in Table 4 were added to the weighed powder materials, which in turn were wet-blended for 16 hours in ball mills employing nylon balls. Thereafter the powder materials were dehydrated, dried and calcined at 1000° C. for 2 hours.

41. Then, the calcined powder materials were treated similarly to Example 1, to obtain NTC elements.

42. Table 4 also shows the results of the respective electric characteristics of the as-obtained NTC elements, which were measured similarly to Example 1.

TABLE 4

| | Additional | Content | Resistivity | B Constant | B Constant |
|---|---|---|---|---|---|
| No. | Element | (mol %) | (Ω · cm) | (−10° C.) (K) | (140° C.) (K) |
| 2-1 | Zr | 1 | 19.1 | 2670 | 4060 |
| 2-2 | Mo | 1 | 20.0 | 2710 | 4320 |
| 2-3 | Sb | 1 | 18.9 | 2430 | 4070 |
| 2-4 | Hf | 0.5 | 16.8 | 2610 | 4150 |
| 2-5 | Ta | 0.5 | 18.3 | 2420 | 4270 |
| 2-6 | Ce | 0.5 | 20.0 | 2590 | 4010 |
| 2-7 | Sb | 1 | 18.2 | 2530 | 3970 |
| | Hf | 1 | | | |
| 2-8 | Zr | 0.05 | 17.0 | 2680 | 4190 |
| | Ta | 0.1 | | | |
| 2-9 | Sn | 0.5 | 16.1 | 2420 | 3870 |
| | Ce | 0.5 | | | |
| 2-10 | Si | 0.05 | 17.3 | 2700 | 4260 |
| | Mo | 0.05 | | | |
| | W | 0.1 | | | |

### EXAMPLE 3

43. This Example was carried out on a rare earth transition element oxide of SmNiO₃.

44. First, SmNiO₃ powder materials were prepared in the following manner: Respective powder materials of Sm₂O₃ and NiO were weighed so that Sm was at a mole ratio of 0.95 to Ni. The additives shown in Table 5 were added to the weighed powder materials, which in turn were wet-blended for 16 hours in ball mills employing nylon balls. Thereafter the powder materials were dehydrated, dried and calcined at 1000° C. for 2 hours.

45. Then, the calcined powder materials were treated similarly to Example 1, to obtain NTC elements.

46. Table 5 also shows the results of the respective electric characteristics of the thus obtained NTC elements, which were measured similarly to Example 1.

TABLE 5

| | Additional | Content | Resistivity | B Constant | B Constant |
|---|---|---|---|---|---|
| No. | Element | (mol %) | (Ω · cm) | (−10° C.) (K) | (140° C.) (K) |
| 3-1 | Zr | 0.05 | 14.8 | 2240 | 3920 |
| 3-2 | Mo | 0.05 | 14.0 | 2340 | 3870 |
| 3-3 | Sb | 1 | 13.8 | 2290 | 3790 |
| 3-4 | Hf | 1 | 12.1 | 2150 | 3740 |
| 3-5 | Ta | 0.5 | 14.3 | 2230 | 3800 |
| 3-6 | W | 0.5 | 15.0 | 2090 | 3750 |
| 3-7 | Sb | 0.5 | 12.9 | 2410 | 3930 |
| | Ce | 0.5 | | | |
| 3-8 | Zr | 0.05 | 14.3 | 2060 | 3620 |
| | Ta | 0.05 | | | |
| 3-9 | Sn | 1 | 12.0 | 2220 | 3890 |
| | W | 1 | | | |
| 3-10 | Si | 0.1 | 13.7 | 2390 | 3990 |
| | Mo | 0.1 | | | |
| | W | 0.1 | | | |

### EXAMPLE 4

47. This Example was carried out on a rare earth transition element oxide of NdNiO₃.

48. First, NdNiO₃ powder materials were prepared in the following manner: Respective powder materials of Nd₂O₃ and NiO were weighed so that Nd was at a mole ratio of 0.95 to Ni. The additives shown in Table 6 were added to the weighed powder materials, which in turn were wet-blended for 16 hours in ball mills employing nylon balls. Thereafter the powder materials were dehydrated, dried and calcined at 1000° C. for 2 hours.

49. Then, the calcined powder materials were treated similarly to Example 1, to obtain NTC elements.

50. Table 6 also shows the results of the respective electric characteristics of the obtained NTC elements, which were measured similarly to Example 1.

TABLE 6

| | Additional | Content | Resistivity | B Constant | B Constant |
|---|---|---|---|---|---|
| No. | Element | (mol %) | (Ω · cm) | (−10° C.) (K) | (140° C.) (K) |
| 4-1 | Si | 0.5 | 24.3 | 2030 | 3860 |
| 4-2 | Zr | 0.5 | 24.0 | 2170 | 3790 |
| 4-3 | Mo | 5 | 25.8 | 2100 | 3910 |
| 4-4 | Sn | 5 | 24.1 | 2090 | 3730 |
| 4-5 | Sb | 1 | 23.6 | 2160 | 3850 |
| 4-6 | Ce | 1 | 22.6 | 2240 | 3930 |
| 4-7 | Si | 1 | 25.9 | 2120 | 3710 |
| | Sn | 1 | | | |
| 4-8 | Zr | 0.5 | 25.4 | 1990 | 3790 |
| | W | 0.5 | | | |
| 4-9 | Mo | 0.5 | 24.3 | 1970 | 3860 |
| | Ta | 0.5 | | | |
| 4-10 | Zr | 0.1 | 24.6 | 2080 | 3900 |
| | Sn | 0.1 | | | |
| | Ta | 0.1 | | | |

### EXAMPLE 5

51. This Example was carried out on a rare earth transition element oxide of PrNiO₃.

52. First, PrNiO₃ powder materials were prepared in the following manner: Respective powder materials of Pr₆P₁₁ and NiO were weighed so that Pr was at a mole ratio of 0.95 to Ni. The additives shown in Table 7 were added to the weighed powder materials, which in turn were wet-blended for 16 hours in ball mills employing nylon balls. Thereafter the powder materials were dehydrated, dried and calcined at 1000° C. for 2 hours.

53. Then, the calcined powder materials were treated similarly to Example 1, to obtain NTC elements.

54. Table 7 also shows the results of the respective electric characteristics of the obtained NTC elements, which were measured similarly to Example 1.

TABLE 7

| | Additional | Content | Resistivity | B Constant | B Constant |
|---|---|---|---|---|---|
| No. | Element | (mol %) | (Ω · cm) | (−10° C.) (K) | (140° C.) (K) |
| 5-1 | Zr | 1 | 10.6 | 1960 | 3650 |
| 5-2 | Mo | 1 | 9.8 | 2100 | 3590 |
| 5-3 | Sb | 0.5 | 11.6 | 2060 | 3710 |
| 5-4 | Te | 0.5 | 8.9 | 1980 | 3690 |
| 5-5 | Ta | 0.05 | 10.3 | 2030 | 3740 |
| 5-6 | W | 0.05 | 12.0 | 2210 | 3820 |
| 5-7 | Zr | 1 | 9.7 | 2120 | 3640 |
| | Hf | 1 | | | |
| 5-8 | Zr | 0.5 | 9.6 | 1990 | 3630 |
| | W | 0.1 | | | |
| 5-9 | Mo | 0.1 | 11.3 | 1970 | 3670 |
| | Sb | 0.1 | | | |
| 5-10 | Sb | 0.5 | 10.2 | 2090 | 3710 |
| | Hf | 0.5 | | | |
| | W | 0.5 | | | |

### EXAMPLE 6

55. This Example was carried out on a rare earth transition element oxide of La_{0.9}Nd_{0.1}CoO₃.

56. First, respective powder materials of La₂O₃, Nd₂O₃ and Co₃O₄ were weighed to obtain La_{0.2}Nd_{0.1}CoO₃ semiconductive ceramic materials. The additives shown in Table 8 were added to the weighed powder materials, which in turn were wet-blended for 16 hours in ball mills employing nylon balls. Thereafter the powder materials were dehydrated, dried and calcined at 1000° C. for 2 hours.

57. Then, the calcined powder materials were treated similarly to Example 1, to obtain NTC elements.

58. Table 8 also shows the results of the respective electric characteristics of the thus obtained NTC elements, which were measured similarly to Example 1.

TABLE 8

| | Additional | Content | Resistivity | B Constant | B Constant |
|---|---|---|---|---|---|
| | Element | (mol %) | (Ω · cm) | (−10° C.) (K) | (140° C.) (K) |
| 6-1 | Zr | 0.5 | 26.1 | 1870 | 3630 |
| 6-2 | Sb | 1 | 25.7 | 1720 | 3690 |
| 6-3 | W | 5 | 26.4 | 1910 | 3590 |
| 6-4 | Si | 1 | 24.0 | 1860 | 3540 |
| | Hf | 1 | | | |
| 6-5 | Zr | 0.5 | 25.6 | 1790 | 3680 |
| | Mo | 0.5 | | | |
| | Ta | 0.5 | | | |

### EXAMPLE 7

59. This Example was carried out on a rare earth transition element oxide of La_{0.9}Gd_{0.1}CoO₃.

60. First, respective powder materials of La₂O₃, Gd₂O₃ and Co₃O₄ were weighed to obtain La_{0.2}Gd_{0.1}CoO₃ semiconductive ceramic materials. Additives shown in Table 8 were added to the weighed powder materials, which in turn were wet-blended for 16 hours in ball mills employing nylon balls. Thereafter the powder materials were dehydrated, dried and calcined at 1000° C. for 2 hours.

61. Then, the calcined powder materials were treated similarly to Example 1, to obtain NTC elements.

62. Table 9 also shows the results of the respective electric characteristics of thus obtained NTC elements, which were measured similarly to Example 1.

TABLE 9

| | Additional | Content | Resistivity | B Constant | B Constant |
|---|---|---|---|---|---|
| No. | Element | (mol %) | (Ω · cm) | (−10° C.) (K) | (140° C.) (K) |
| 7-1 | Sn | 0.01 | 22.0 | 2010 | 3750 |
| 7-2 | Ta | 0.5 | 21.9 | 1960 | 3710 |
| 7-3 | Ce | 1 | 23.7 | 1840 | 3860 |
| 7-4 | Zr | 0.1 | 22.4 | 2020 | 3650 |
| | Mo | 0.1 | | | |
| 7-5 | Zr | 0.5 | 23.7 | 1970 | 3700 |
| | Te | 0.5 | | | |
| | Hf | 0.5 | | | |

### EXAMPLE 8

63. This Example was carried out on a rare earth transition element oxide of La_{0.99}Y_{0.01}MnO₃.

64. First, respective powder materials of La₂O₃, Y₂O₃ and MnO were weighed to obtain La_{0.99}Y_{00.1}MnO₃ semiconductive ceramic materials. The additives shown in Tables 8 were added to the weighed powder materials, which in turn were wet-blended for 16 hours in ball mills employing nylon balls. Thereafter the powder materials were dehydrated, dried and calcined at 1000° C. for 2 hours.

65. Then, the calcined powder materials were treated similarly to Example 1, to obtain NTC elements.

66. Table 10 also shows the results of the respective electric characteristics of the thus obtained NTC elements, which were measured similarly to Example 1.

TABLE 10

| | Additional | Content | Resistivity | B Constant | B Constant |
|---|---|---|---|---|---|
| No. | Element | (mol %) | (Ω · cm) | (−10° C.) (K) | (140° C.) (K) |
| 8-1 | Sn | 5 | 20.6 | 2190 | 3970 |
| 8-2 | Mo | 1 | 21.5 | 2290 | 3860 |
| 8-3 | W | 0.5 | 19.7 | 2200 | 3900 |
| 8-4 | Sb | 0.5 | 20.1 | 2260 | 3840 |
| | Ta | 0.5 | | | |
| 8-5 | Zr | 1 | 20.6 | 2270 | 3820 |
| | Sb | 1 | | | |
| | Mo | 1 | | | |

67. Although the aforementioned Examples were carried out on oxides of LaCoO₃, LaCrO₃, SmNiO₃, NdNiO₃ and PrNiO₃ respectively, the present invention is also applicable to other rare earth transition element oxides, to attain similar effects.

### EXAMPLE 9

68. LaCoO₃ powders were first prepared as follows: Respective powder materials of Co₃O₄ and La₂O₃ were weighed so that La was at a mole ratio of 0.939, 0.964, 0.989, 1.014, 1.039 to Co, respectively, to obtain five kinds of mixed powder materials. ZrO₂, the amount of which is 0.1 mole % in terms of Zr, was added to each of the mixed powder materials, which in turn were wet-blended for 16 hours in ball mills employing nylon balls. Thereafter, the blended materials were dehydrated, dried and calcinated at 1000°C. for 2 hours. The * shown in Table 11 means that the amount of the additive Zr is outside the scope of the present invention.

69. Then, the calcinated powder materials were pulverized by jet mills. Binders were added to the pulverized powder materials, which in turn were again wet-blended for 5 hours in ball mills employing nylon balls, and then filtered, dried, and thereafter pressure molded into the form of disks. The disks were fired in the air at 140°C. for 2 hours, to obtain the semiconductive sintered bodies according to Examples 9-1, 9-2, 9-3, 9-4, 9-5.

70. The semiconductive sintered bodies were subjected to disintegration test as follows: in Table 11, the PCT Test means that the sintered body was left at 121°C. under 2 barometric pressures and relative humidity of 100% for 100 hours, and disintegration was observed. The Humidity Shelf Test means that the sintered body was left at 60°C. under 1 barometric pressure and relative humidity of 95% for 1000 hours. The Shelf Test means that the sintered body was left at a room temperature under 1 barometric pressure and atmosphere for 1000 hours. The appearance of the sintered body was observed after these tests. The results are shown in Table 11.

TABLE 11

| | | | | Humidity | Shelf |
|---|---|---|---|---|---|
| NO. | La/Co | Zr | PCT Test | Shelf Test | Test |
| 1 | 0.939 | 1 mol % | no change | no change | no change |
| 2 | 0.964 | 1 mol % | no change | no change | no change |
| 3 | 0.989 | 1 mol % | no change | no change | no change |
| 4* | 1.014 | 1 mol % | partially | partially | no change |
| | | | broken to | broken to | |
| | | | sand like | sand like | |
| | | | powders | powders | |
| 5* | 1.039 | 1 mol % | broken to | broken to | broken to |
| | | | sand like | sand like | sand like |
| | | | powers | powders | powders |

71. As can be seen from Table 11, in the case of La/Co≦0.989, no changes were observed in any of these tests. In the case of La/Co=1.014, parts of some of the sintered bodies broke to sand like powders in the PCT Test and the Humidity Shelf Test. Further, in the case of La/Co=1.039, the entire sintered bodies broke to sand like powders in the Shelf Test as well.

72. Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A semiconductive material having a negative temperature coefficient of resistance comprising (a) a negative temperature coefficient of resistance semiconductive ceramic comprising a rare earth transition element oxide excluding Ce and including Y, and (b) at least one element selected from the group consisting of Si, Zr, Hf, Ta, Sn, Sb, W, Mo, Te and Ce as an additive to said rare earth transition element oxide.

2. The semiconductive material having a negative temperature coefficient of resistance in accordance with claim 1, wherein the mole percent of said additive is about 0.001 to 10.

3. The semiconductive material having a negative temperature coefficient of resistance in accordance with claim 1, wherein the mole percent of said additive is about 0.1 to 5.

4. The semiconductive material having a negative temperature coefficient of resistance in accordance with claim 1, wherein said rare earth transition element oxide is an oxide being selected from a group of respective oxides of LaCoO₃, LaCrO₃, LaMnO₃, SmNiO₃, NdNiO₃ and PrNiO₃.

5. The semiconductive material having a negative temperature coefficient of resistance in accordance with claim 11, wherein said rare earth transition element oxide ALaCoO₃ is La_{0.9}Nd_{0.1}CoO₃.

6. The semiconductive material having a negative temperature coefficient of resistance in accordance with claim 11, wherein said rare earth transition element oxide ALaCoO₃ is La_{0.9}Gd_{0.1}CoO₃.

7. The semiconductive material having a negative temperature coefficient of resistance in accordance with claim 11, wherein said rare earth transition element oxide ALaCoO₃ is La_{0.99}Y_{0.01}CoO₃.

8. The semiconductive material having a negative temperature coefficient of resistance in accordance with claim 1, in combination with a circuit for preventing an inrush current.

9. The semiconductive material having a negative temperature coefficient of resistance in accordance with claim 1, in combination with a circuit for delaying motor starting.

10. The semiconductive material having a negative temperature coefficient of resistance in accordance with claim 1, wherein the rare earth transition element oxide includes a rare earth element and a transition element, and the mole ratio of the rare earth element to the transition element is within a range of 0.6 to 1.1.

11. The semiconductive material having a negative temperature coefficient of resistance in accordance with claim 1, wherein said rare earth transition element oxide is of the formula ACoO₃, ACrO₃, AMnO₃, or BNiO₃, wherein A includes the element La and B includes at least one element selected from the group consisting of Sm, Nd and Pr.

12. The semiconductive material having a negative temperature coefficient of resistance in accordance with claim 1, wherein the rare earth transition element oxide includes a rare earth element and a transition element, and the mole ratio of the rare earth element to the transition element is within a range of 0.6 to 0.989.

13. The semiconductive material having a negative temperature coefficient of resistance in accordance with claim 12, wherein the rare earth element is La and the transition element is Co.

14. The semiconductive material having a negative temperature coefficient of resistance in accordance with claim 1, wherein the mole percent of said additive is about 0.001 to 1.
